(19) United States
(12) Patent Application Publication
(10) Pub. No.: US 2023/0327145 A1
(43) Pub. Date: Oct. 12, 2023

(54) FUEL CELL

(71) Applicants: JTEKT CORPORATION, Kariya-shi (JP); NATIONAL UNIVERSITY CORPORATION kANAZAWA UNIVERSITY, Kanazawa-shi (JP)

(72) Inventors: Takuya TSUJIGUCHI, Kanazawa-shi (JP); Noriyasu HAYASHI, Anjo-shi (JP); Toshiyuki SAITO, Kashiba-shi (JP); Motoo NAKAI, Nara-shi (JP); Atsushi KUBO, Matsubara-shi (JP); Akihiro TAKAZATO, Kashiwara-shi (JP)

(73) Assignees: JTEKT CORPORATION, Kariya-shi (JP); NATIONAL UNIVERSITY CORPORATION KANAZAWA UNIVERSITY, Kanazawa-shi (JP)

(21) Appl. No.: 17/768,387

(22) PCT Filed: Oct. 14, 2020
(86) PCT No.: PCT/JP2020/038743

§ 371 Date: Jun. 30, 2023

(30) Foreign Application Priority Data
Oct. 16, 2019 (JP) 2019-189185

(51) Int. Cl. H01M 8/026; H01M 8/04082; H01M 8/0265

(52) U.S. Cl. CPC H01M 8/026; H01M 8/04201; H01M 8/0265; H01M 8/0263

(57) ABSTRACT

A fuel flow groove formed in a fuel electrode current collector of a fuel electrode of a fuel cell includes a plurality of flow groove portions disposed in parallel, and a plurality of return groove portions connecting an end portion of one side edge portion or an end portion of the other side edge portion of the flow groove portions of two adjacent groups. Each of the return groove portions has an inner wall surface portion facing the end portion of the flow groove portions in the return groove portions. The inner wall surface portion has a curved surface shape in which a distance facing each other from the inner wall surface portion to the end portion of the flow groove portions, gradually decreases toward both end portions of the inner side wall surface portion in a direction orthogonal to an extending direction of the flow groove portions.

### TECHNICAL FIELD

The present disclosure relates to a fuel cell.

### BACKGROUND ART

In recent years, various techniques relating to a fuel cell using a liquid fuel such as formic acid and methanol have been proposed as fuel cells. For example, a fuel cell disclosed in JP2007-095692A is provided with a plurality of electricity generation units disposed at regular intervals in a longitudinal direction so as to face each other on both sides of a separator having insulation properties. Each of the electricity generation units includes an anode portion disposed in close contact with each of both sides of the separator, a membrane-electrode assembly (MEA) disposed in close contact with the anode portion, and a cathode portion disposed in close contact with the MEA.

The anode portion is provided with a first flow path. The first flow path is arranged in a linear state at an arbitrary interval along a length direction of a first path member having a vertically long rectangular shape, is formed in a meandering shape by alternately connecting both ends thereof, and penetrates the first path member in a thickness direction. One end portion (lower-side end portion) of the first flow path communicates with an outflow port of a manifold formed in the separator. The other end portion (upper-side end portion) of the first flow path communicates with an inflow port of the manifold. Accordingly, a fuel flows from the inflow port of the manifold, through the first flow path formed in the meandering shape, and back to the manifold via the upper-side outflow port, and is distributed and supplied to a first electrode layer of the MEA.

However, in the fuel cell disclosed in JP2007-095692A, since both end portions of the first flow path are bent at a substantially right angle, carbon dioxide (CO) generated by oxidizing the fuel and the fuel may stay at a corner portion on an upper side of the flow path connecting the both end portions in an up-down direction, the fuel may be less likely to flow smoothly, and the power generation amount may be reduced.

### SUMMARY OF INVENTION

The present disclosure provides a fuel cell capable of preventing a fuel and carbon dioxide from stagnating in a fuel flow groove formed in a fuel electrode and suppressing a decrease in power generation amount.

According to a first aspect of the present disclosure, a fuel cell being a direct liquid fuel cell in which a liquid containing a formic acid or an alcohol is used as a fuel includes: a fuel electrode that includes a fuel electrode catalyst layer, a fuel electrode diffusion layer, and a fuel electrode current collector; an air electrode that includes an air electrode catalyst layer, an air electrode diffusion layer, and an air electrode current collector, and an electrolyte membrane that is disposed between the fuel electrode catalyst layer and the air electrode catalyst layer. The fuel electrode current collector has: a fuel inflow port to which the fuel is supplied; a fuel outflow port from which the fuel is discharged; and a fuel flow groove that is formed on a fuel flow surface on a side abutting the fuel electrode diffusion layer and guides the fuel from the fuel inflow port to the fuel outflow port. The fuel flow groove has: a plurality of flow groove portions that extend from one side edge portion of the fuel flow surface to the other side edge portion opposite to the one side edge portion and that are disposed in parallel at predetermined intervals; and a plurality of return groove portions that, in a manner of containing a plurality of groups adjacent to each other with directions of the fuel flowing in the plurality of flow groove portions being opposite, connect an end portion of the one side edge portion or an end portion of the other side edge portion of two adjacent groups among the plurality of groups in the plurality of flow groove portions. Each of the plurality of return groove portions has a first inner wall surface portion facing the end portion of the flow groove portions in the plurality of return groove portions. The first inner wall surface portion has a curved surface shape in which a distance facing with each other from the first inner wall surface portion to the end portion of the flow groove portions, gradually decreases toward both end portions of the first inner wall surface portion in a direction orthogonal to an extending direction of the flow groove portions.

According to a second aspect of the present disclosure, the fuel flow groove has an inflow groove portion that is connected to the fuel inflow port and to which an end portion on a side opposite to the return groove portion of one group among the plurality of groups in the plurality of flow groove portions is connected, the one group of the plurality of flow groove portions being configured such that the fuel first flows therein. The inflow groove portion has a second inner wall surface portion facing the end portion of the flow groove portions in the inflow groove portion. The second inner wall surface portion has a curved surface shape in which a distance facing with each other from the second inner wall surface portion to the end portion of the flow groove portions, gradually decreases toward an outflow side end portion of the second inner wall surface portion in a direction orthogonal to an extending direction of the flow groove portions.

According to a third aspect of the present disclosure, the fuel flow groove has an outflow groove portion that is connected to the fuel outflow port and to which an end portion on a side opposite to the return groove portion of one group among the plurality of groups in the plurality of flow groove portions is connected, the one group of the plurality of flow groove portions being configured such that the fuel lastly flows therein. The outflow groove portion has a third inner wall surface portion facing the end portion of the flow groove portions in the outflow groove portion. The third inner wall surface portion has a curved surface shape in which a distance facing with each other from the third inner wall surface portion to the end portion of the flow groove portions, gradually decreases toward an inflow side end portion of the third inner wall surface portion in a direction orthogonal to an extending direction of the flow groove portions.

According to a fourth aspect of the present disclosure, the fuel flow groove has a plurality of rib portions that are disposed between the plurality of flow groove portions. The plurality of rib portions have a plurality of protruding portions protruding in a circular arc shape in a plan view outward from the flow groove portions, at the end portion of the flow groove portions facing each of the first inner wall surface portion, the second inner wall surface portion, and the third inner wall surface portion.

According to a fifth aspect of the present disclosure, the plurality of protruding portions protruding into the return groove portion are formed such that a protruding height of the protruding portion gradually decreases from both end portions of the return groove portion in a direction orthogonal to the extending direction of the flow groove portions toward a boundary, at which a direction of the fuel flowing in the two groups is reversed, between two groups of the flow groove portions among the plurality of groups.

According to the first aspect, in the fuel electrode current collector, the fuel flow groove that guides the fuel containing formic acid or alcohol from the fuel inflow port to the fuel outflow port is formed on the fuel flow surface on the side abutting the fuel electrode diffusion layer. The fuel flow groove includes a plurality of flow groove portions that extend from one side-edge side of the fuel flow surface to the other side-edge side opposite to the one side edge and that are disposed in parallel at predetermined intervals, and a plurality of return groove portions that, in a manner of forming a plurality of groups adjacent to each other with directions of the fuel flowing in two adjacent groups of the plurality of flow groove portions being opposite to each other, connect the end portions of the one side edge portion or the end portions of the other side edge portion of two adjacent groups of the plurality of flow groove portions. The inner wall surface portion facing the end portion of the flow groove portion of each of the plurality of return groove portions is formed in a curved surface shape in which the distance from the inner wall surface portion to the end portion of the flow groove portion, which face each other, gradually decreases toward both end portions in the direction orthogonal to the extending direction of the flow groove portion.

Accordingly, in the plurality of return groove portions formed on the fuel flow surface of the fuel electrode, the distance from the inner wall surface portion to the end portion of the flow groove portion decreases toward both end portions in the direction orthogonal to the extending direction of the flow groove portion, and thus the fuel and carbon dioxide stagnating at both end portions in the direction orthogonal to the extending direction of the flow groove portion can be reduced. Further, since the fuel flowing out of the flow groove portion into the return groove portion flows along the inner wall surface portion of the return groove portion and smoothly flows into the plurality of flow groove portions on the downstream side in flowing, the reaction of the fuel by the fuel electrode catalyst layer increases, and a decrease in the power generation amount can be suppressed.

According to the second aspect, the fuel flow groove has the inflow groove portion that is connected to the fuel inflow port and to which an end portion on the side opposite to the return groove portion of the group of the plurality of flow groove portions is connected, the fuel first flowing into the group of the plurality of flow groove portions. The inner wall surface portion facing the end portion of the flow groove portion of the inflow groove portion is formed in a curved surface shape in which the distance from the inner wall surface portion to the end portion of the flow groove portion, which face each other, gradually decreases toward the outflow side end portion in the direction orthogonal to the extending direction of the flow groove portion. Accordingly, in the inflow groove portion, the fuel or carbon dioxide stagnating at the outflow side end portion in the direction orthogonal to the extending direction of the flow groove portion can be reduced, and the fuel flowing in from the fuel inflow port can be smoothly guided to the plurality of flow groove portions. As a result, the reaction of the fuel by the fuel electrode catalyst layer increases, and a decrease in the power generation amount can be suppressed.

According to the third aspect, the fuel flow groove has the outflow groove portion that is connected to the fuel outflow port and to which an end portion on the side opposite to the return groove portion of the group of the plurality of flow groove portions is connected, the fuel lastly flowing into the group of the plurality of flow groove portions. The inner wall surface portion facing the end portion of the flow groove portion of the inflow groove portion is formed in a curved surface shape in which the distance from the inner wall surface portion to the end portion of the flow groove portion, which face each other, gradually decreases toward the inflow side end portion in the direction orthogonal to the extending direction of the flow groove portion. Accordingly, the fuel or carbon dioxide stagnating at the inflow side end portion in the direction orthogonal to the extending direction of the flow groove portion of the outflow groove portion can be reduced, and the fuel flowing from the plurality of flow groove portions can be smoothly guided to the fuel outflow port. As a result, the reaction of the fuel by the fuel electrode catalyst layer increases, and a decrease in the power generation amount can be suppressed.

According to the fourth aspect, the plurality of rib portions disposed between the flow groove portions have, at the end portion facing the inner wall surface portion, a protruding portion that protrudes in a circular arc shape in a plan view toward an outer side with respect to the adjacent flow groove portions. Accordingly, the fuel flowing out of the flow groove portion can be smoothly guided along the outer peripheral surface of the protruding portion to the downstream side in the direction orthogonal to the extending direction of the flow groove portion, and then smoothly guided again into the flow groove portion disposed on the downstream side, and the fuel and carbon dioxide stagnating at the end portions in the direction orthogonal to the extending direction of the flow groove portion of the return groove portion, the inflow groove portion, or the outflow groove portion can be further reduced.

According to the fifth aspect, the plurality of protruding portions protruding into the return groove portion are formed such that the protruding height gradually decreases from both end portions in the direction orthogonal to the extending direction of the flow groove portion of the return groove portion, toward a portion between two groups of the plurality of flow groove portions, flow directions of the fuel in the two groups being reversed. Accordingly, the fuel flowing into the return groove portion from the flow groove portion can be guided so as to smoothly flow in a substantially central portion in the direction orthogonal to the extending direction of the flow groove portion, and the fuel and carbon dioxide stagnating at both end portions in the direction orthogonal to the extending direction of the flow groove portion of the return groove portion can be further reduced.

### BRIEF DESCRIPTION OF DRAWINGS

FIG. 1 is a perspective view illustrating an overall configuration of a fuel cell system according to an embodiment.

FIG. 2 is an exploded perspective view illustrating a configuration of a fuel cell according to the present embodiment.

FIG. 3 is a front view of the fuel electrode current collector as viewed from a fuel flow surface.

FIG. 4 is an enlarged view of a portion IV in FIG. 3.

FIG. 5 is an enlarged perspective view as viewed along an arrow V of FIG. 4.

FIG. 6 is a diagram illustrating an example of flow speed distribution of a fuel flowing through the fuel electrode current collector illustrated in FIG. 3.

FIG. 7 is a front view of a fuel electrode current collector according to a comparative example as viewed from a fuel flow surface.

FIG. 8 is an enlarged perspective view of a portion VIII in FIG. 7.

FIG. 9 is a diagram illustrating an example of flow speed distribution of a fuel flowing through the fuel electrode current collector illustrated in FIG. 7.

FIG. 10 is an enlarged perspective view of a fuel electrode current collector according to another first embodiment.

### DESCRIPTION OF EMBODIMENTS

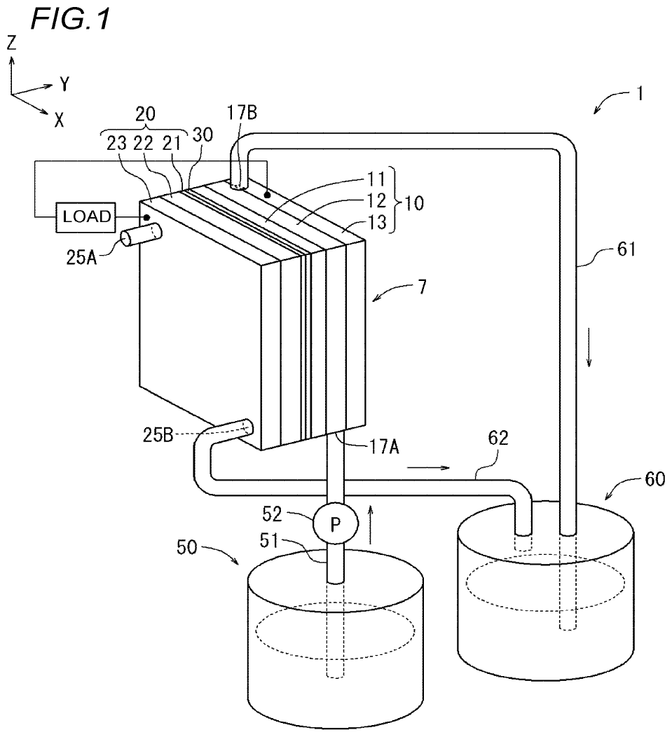

Hereinafter, a fuel cell according to an embodiment of the present disclosure will be described in detail with reference to the accompanying drawings. First, a schematic configuration of a fuel cell system 1 including a fuel cell 7 according to the present embodiment will be described with reference to FIG. 1. The fuel cell 7 of the fuel cell system 1 to be described in the present embodiment is a direct liquid fuel cell using an aqueous solution of formic acid or alcohol such as methanol as fuel, and a direct formic acid fuel cell using formic acid as fuel will be described as an example thereof in the following description.

Here, the direct liquid fuel cell refers to a fuel cell in which a liquid fuel is directly supplied to a fuel electrode without being reformed. Further, a direct formic acid fuel cell is a fuel cell, in which formic acid is used as fuel and is directly supplied to a fuel electrode 10 (see FIG. 1) constituting the fuel cell 7 without being reformed. Note that in the drawings, an X axis, a Y axis, and a Z axis are orthogonal to one another. A Z-axis direction corresponds to an up-down direction (vertical direction), a Y-axis direction corresponds to a thickness direction, and an X-axis direction corresponds to a horizontal width direction.

[Schematic Configuration of Fuel Cell System]

As illustrated in FIG. 1, the fuel cell system 1 includes a fuel tank 50, a pump 52, the fuel cell 7, a waste-liquid tank 60, and the like. A solution containing formic acid of a predetermined concentration (aqueous solution of formic acid) is stored in the fuel tank 50. The concentration of the formic acid in the aqueous solution is, for example, about 10% to about 40%. One end of a fuel supply pipe 51 is connected to the fuel tank 50. The other end of the fuel supply pipe 51 is connected to a fuel inflow port 17A that opens at a lower end portion of the fuel cell 7. The pump 52 is an electric pump, is disposed in the middle of the fuel supply pipe 51, and supplies (pumps) the fuel in the fuel tank 50 to the fuel inflow port 17A of the fuel cell 7.

The fuel, which is discharged after being used in the fuel cell 7, and water, which is generated and is recovered at an air electrode 20 constituting the fuel cell 7, are stored in the waste-liquid tank 60. The other end of a fuel discharge pipe 61 is connected to the waste-liquid tank 60. One end of the fuel discharge pipe 61 is connected to a fuel outflow port 17B that opens at an upper end portion of the fuel cell 7. The other end of a recovery pipe 62 is connected to the waste-liquid tank 60. One end of the recovery pipe 62 is connected to an air outflow port 25B provided on a lower side of the air electrode 20.

Further, an exhaust port (not shown) that communicates an inside and an outside is provided in an upper portion of the waste-liquid tank 60. When pressure of a gas in the waste-liquid tank 604) becomes higher than predetermined pressure, the gas in the waste-liquid tank 60 is discharged to the outside of the waste-liquid tank 60 from the exhaust port (not shown) provided in the upper portion thereof. In addition, the fuel cell 7 generates electric power using the fuel flowing in from the fuel inflow port 17A and discharged from the fuel outflow port 17B. A structure of the fuel cell 7 will be described in detail below.

[Schematic Configuration of Fuel Cell]

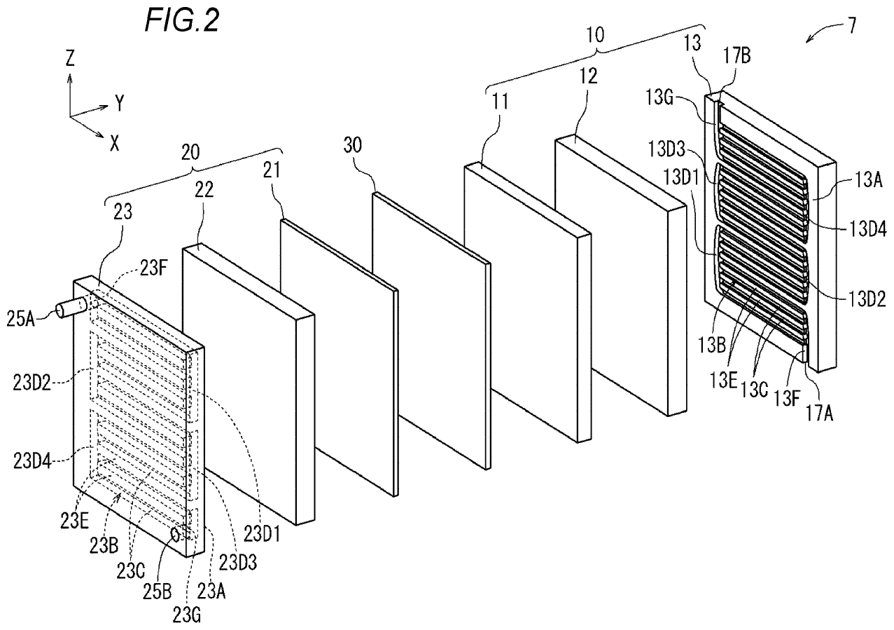

Next, a schematic configuration of the fuel cell 7 will be described with reference to FIGS. 1 and 2. As illustrated in FIGS. 1 and 2, the fuel cell 7 is configured integrally with the air electrode 20 and the fuel electrode 10 sandwiching an electrolyte membrane 30 therebetween in the thickness direction. The air electrode 20 is formed by stacking an air electrode catalyst layer 21, an air electrode diffusion layer 22, and an air electrode current collector 23, which are in close contact with one surface of the electrolyte membrane 30, in this order. The fuel electrode 10 is formed by stacking a fuel electrode catalyst layer 11, a fuel electrode diffusion layer 12, and a fuel electrode current collector 13, which are in close contact with the other surface of the electrolyte membrane 30, in this order.

The air electrode current collector 23 is formed of, for example, a flat plate-shaped metal having a thickness of about 1 [mm] to 10 [mm] and having conductivity. As illustrated in FIG. 1, one end of an electric load (for example, an electric motor) is electrically connected to the air electrode current collector 23. As illustrated in FIG. 2, the air electrode current collector 23 has an air flow surface 23A abutting the air electrode diffusion layer 22, and an air flow groove 23B opened on the air electrode diffusion layer 22 side is formed on the air flow surface 23A.

The air flow groove 23B guides air, which is supplied (pumped) from the air inflow port 25A formed on an upper side of a diagonal line with respect to the air outflow port 25B of the air electrode current collector 23, to the air outflow port 25B formed on a lower side of the air electrode current collector 23 while bringing the air into contact with the air electrode diffusion layer 22. Accordingly, the air flowing in the air flow groove 23B is diffused into the air electrode diffusion layer 22. Note that dried oxygen may be supplied (pumped) from the outside to the air inflow port 25A.

The air flow groove 23B is provided with a plurality of flow groove portions 23C that extend in a width direction from one side-edge side (for example, a left side-edge side in FIG. 2) of the air flow surface 23A to the other side-edge side (for example, a right side-edge side in FIG. 2) opposite to the one side-edge, that are arranged in parallel with one another at predetermined intervals, and in which air flows. Further, land portions (rib portions) 23E abutting the air electrode diffusion layer 22 are formed between the flow groove portions 23C in the up-down direction so as to have a width in the up-down direction substantially the same as a width of the flow groove portion 23C in the up-down direction, for example. The land portion (rib portion) 23E electrically connects the air electrode current collector 23 and the air electrode diffusion layer 22.

The air inflow port 25A is connected to an inflow groove portion 23F that extends in the vertical direction at an upper left corner in FIG. 2. The air outflow port 25B is connected to an outflow groove portion 23G that extends in the vertical direction at a lower right corner in FIG. 2. The plurality of flow groove portions 23C are connected by return groove portions 23D1 to 23D4 that extend in a substantially vertical direction and that are formed in the vicinity of one side edge of the air electrode current collector 23 or the other side edge thereof. In addition, the plurality of flow groove portions 23C are connected to the inflow groove portion 23F at the upper left corner in FIG. 2, and are connected to the outflow groove portion 23G at the lower right corner in FIG. 2.

Accordingly, air flowing into the inflow groove portion 23F from the air inflow port 25A is guided from one side edge to the other side edge in the flow groove portions 23C, is repeatedly changed in direction by the return groove portions 23D1 to 23D4 to flow in the air flow groove 23B, and is diffused into the air electrode diffusion layer 22. Thereafter, the air flowing into the outflow groove portion 23G flows from the air outflow port 25B to the recovery pipe 62 (see FIG. 1).

The air electrode diffusion layer 22 is formed in a layer having a thickness of about 0.05 [mm] to about 0.5 [mm]. The air electrode diffusion layer 22 is a porous material having electron conductivity that allows water and air to pass through. For example, carbon paper or carbon cloth may be used as the air electrode diffusion layer 22. The air electrode diffusion layer 22 guides air (oxygen), which flows from the air inflow port 25A of the air electrode current collector 23, to the air electrode catalyst layer 21 while diffusing the air (oxygen). Oxygen contained in the outside air penetrates the air electrode diffusion layer 22 and reaches electrode catalyst particles of the air electrode catalyst layer 21.

The air electrode catalyst layer 21 is formed in a layer having a thickness of about 0.05 [mm] to 0.5 [mm]. The air electrode catalyst layer 21 includes electrode catalyst particles (not shown) of the air electrode and an electrode catalyst support (not shown) supporting the electrode catalyst particles. The electrode catalyst particles of the air electrode 20 are particles of a catalyst for promoting a reaction rate in a reaction which reduces oxygen in the air. For example, platinum (Pt) particles may be used as the electrode catalyst particles. It is preferable that the electrode catalyst support can support the electrode catalyst particles and has conductivity. For example, carbon powder may be used as the electrode catalyst support. When formic acid is used as the fuel, the redox reaction represented by the following formula (I) proceeds by the electrode catalyst particles of the air electrode catalyst layer 21. Note that the generated water (H₂O) flows in the air flow groove 23B and is guided from the air outflow port 25B of the air electrode current collector 23 to the waste-liquid tank 60 via the recovery pipe 62 (see FIGS. 1 and 2).

2H⁺+½O₂+2e⁻→H₂O (1)

The fuel electrode current collector 13 is formed of a flat plate-shaped metal having a thickness of about 1.0 [mm] to about 10 [mm]. The fuel electrode current collector 13 has a fuel flow surface 13A abutting the fuel electrode diffusion layer 12, and a fuel flow groove 13B opened on the fuel electrode diffusion layer 12 side is formed on the fuel flow surface 13A. The fuel flow groove 13B guides fuel supplied from the fuel inflow port 17A formed on a lower side of the fuel electrode current collector 13 to the fuel outflow port 17B formed on an upper side of the fuel electrode current collector 13 while bringing the fuel into contact with the fuel electrode diffusion layer 12. Accordingly, the fuel flowing in the fuel flow groove 13B is diffused into the fuel electrode diffusion layer 12.

The fuel flow groove 13B is provided with a plurality of flow groove portions 13C that extend in a width direction from one side-edge side (for example, a right side-edge side in FIG. 2) of the fuel flow surface 13A to the other side-edge side (for example, a left side-edge side in FIG. 2) opposite to the one side edge, that are arranged in parallel at predetermined intervals, and in which the fuel flows. In addition, rib-shaped land portions (rib portions) 13E abutting on the fuel electrode diffusion layer 12 in order to recover electrons e⁻ are formed between the flow groove portions 13C in the up-down direction so as to have a width in the up-down direction substantially the same as a width of the flow groove portion 13C in the up-down direction, for example. As illustrated in FIG. 1, the other end of the electric load (for example, the electric motor) is connected to the fuel electrode current collector 13.

The fuel electrode diffusion layer 12 is formed in a layer having a thickness of about 0.05 [mm] to 0.5 (mm). The fuel electrode diffusion layer 12 is a porous material having electron conductivity that allows the aqueous solution of formic acid to penetrate into the inside thereof. For example, carbon paper or carbon cloth may be used as the fuel electrode diffusion layer 12. The fuel electrode diffusion layer 12 guides the fuel flowing in the fuel flow groove 13B formed on the fuel flow surface 13A of the fuel electrode current collector 13 to the fuel electrode catalyst layer 11 while diffusing the fuel.

The fuel electrode catalyst layer 11 is formed in a layer having a thickness of about 0.05 [mm] to 0.5 [mm]. The fuel electrode catalyst layer 11 includes electrode catalyst particles (not shown) and an electrode catalyst support (not shown) supporting the electrode catalyst particles. The electrode catalyst particles of the fuel electrode 10 are particles of a catalyst for promoting an oxidation reaction rate of formic acid, which is the fuel. For example, palladium (Pd) particles may be used as the electrode catalyst particles. It is preferable that the electrode catalyst support can support the electrode catalyst particles and has conductivity. For example, carbon powder may be used as the electrode catalyst support. When formic acid is used as the fuel, the oxidation reaction represented by the following formula (2) proceeds by the electrode catalyst particles of the fuel electrode catalyst layer 11.

HCOOH→CO₂+2H⁺+2e⁻ (2)

The electrolyte membrane 30 is formed in a thin film shape having a thickness of about 0.01 [mm] to about 0.3 [mm]. The electrolyte membrane 30 is sandwiched between the fuel electrode catalyst layer 11 of the fuel electrode 10 and the air electrode catalyst layer 21 of the air electrode 20, and is a proton exchange membrane having no electron conductivity that allows water and hydrogen ion (proton) H⁺ to pass through. As the electrolyte membrane 30, for example, a perfluoroethylene sulfonic acid-based membrane such as Nafion (registered trademark) manufactured by DuPont may be used. Note that the fuel electrode catalyst layer 11, the fuel electrode diffusion layer 12, the electrolyte membrane 30, the air electrode catalyst layer 21, and the air electrode diffusion layer 22 may be joined and integrated.

[Configuration of Fuel Flow Groove]

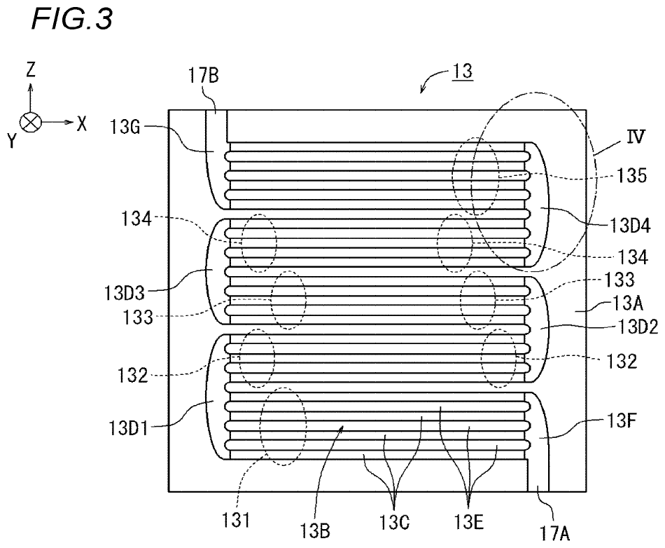

Next, a configuration of the fuel flow groove 13B formed in the fuel electrode current collector 13 will be described with reference to FIGS. 2 to 5. As illustrated in FIGS. 2 and 3, the fuel flow groove 13B is provided with the plurality of flow groove portions 13C that extend in the horizontal width direction from the one side-edge side (for example, the right side-edge side in FIG. 2) of the fuel flow surface 13A to the other side-edge side (for example, the left side-edge side in FIG. 2), that are arranged in parallel at predetermined intervals, and in which the fuel flows.

End portions on the one side-edge side (a right side in FIG. 3) of four flow groove portions 13C on a lower end side are connected to an inflow groove portion 13F having an upper half shape of a semi-ellipse in a front view that extends upward from the fuel inflow port 17A formed in the lower end portion and that protrudes outward in the width direction. In addition, end portions on the other side-edge side (a left side in FIG. 3) of the four flow groove portions 13C on the lower end side, and end portions on the other side-edge side (the left side in FIG. 3) of three flow groove portions 13C on an upper side thereof, are connected to, for example, a return groove portion 13D1 having a semi-elliptical shape in a front view that extends in the up-down direction and that protrudes outward in the width direction.

Accordingly, the fuel flowing into the inflow groove portion 13F from the fuel inflow port 17A flows into the four flow groove portions 13C on the lower end side, flows toward the other side-edge side (the left side in FIG. 3), and flows to a lower side of the return groove portion 13D1. Then, the fuel flowing into the return groove portion 13D1 flows into the three flow groove portions 13C disposed on an upper side of the return groove portion 13D1, and flows toward the one side-edge side (the right side in FIG. 3). Accordingly, the four flow groove portions 13C on the lower end side and the three flow groove portions 13C on the upper side thereof constitute two groups, that is, flow groove portion groups 131 and 132 adjacent to each other in which flow directions of the fuel are opposite to each other.

In addition, end portions on the one side-edge side (the right side in FIG. 3) of the three flow groove portions 13C constituting the flow groove portion group 132, and end portions on the one side-edge side (the right side in FIG. 3) of three flow groove portions 13C on an upper side thereof, are connected to, for example, a return groove portion 13D2 having a semi-elliptical shape in a front view that extends in the up-down direction and that protrudes outward in the width direction.

Accordingly, the fuel flowing to a lower side of the return groove portion 13D2 from the three flow groove portions 13C constituting the flow groove portion group 132 flows into the three flow groove portions 13C disposed on an upper side of the return groove portion 13D2, and flows toward the other side-edge side (the left side in FIG. 3). Accordingly, the three flow groove portions 13C disposed on the upper side of the three flow groove portions 13C constituting the flow groove portion group 132 are disposed adjacently on the upper side of the flow groove portion group 132, and constitute one group, that is, a flow groove portion group 133 in which the flow direction of the fuel is reversed.

In addition, end portions on the other side-edge side (the left side in FIG. 3) of the three flow groove portions 13C constituting the flow groove portion group 133, and end portions on the other side-edge side (the left side in FIG. 3) of three flow groove portions 13C on an upper side thereof, are connected to, for example, a return groove portion 13D3 having a semi-elliptical shape in a front view that extends in the up-down direction and that protrudes outward in the width direction.

Accordingly, the fuel flowing to a lower side of the return groove portion 13D3 from the three flow groove portions 13C constituting the flow groove portion group 133 flows into the three flow groove portions 13C disposed on an upper side of the return groove portion 13D3, and flows toward the one side-edge side (the right side in FIG. 3). Accordingly, the three flow groove portions 13C disposed on the upper side of the three flow groove portions 13C constituting the flow groove portion group 133 are disposed adjacently on the upper side of the flow groove portion group 133, and constitute one group, that is, a flow groove portion group 134 in which the flow direction of the fuel is reversed.

In addition, end portions on the one side-edge side (the right side in FIG. 3) of the three flow groove portions 13C constituting the flow groove portion group 134, and end portions on the one side-edge side (the right side in FIG. 3) of four flow groove portions 13C on an upper side thereof, are connected to, for example, a return groove portion 13D4 having a semi-elliptical shape in a front view that extends in the up-down direction and that protrudes outward in the width direction.

Accordingly, the fuel flowing to a lower side of the return groove portion 13D4 from the three flow groove portions 13C constituting the flow groove portion group 134 flows into the four flow groove portions 13C disposed on an upper side of the return groove portion 131D4, and flows toward the other side-edge side (the left side in FIG. 3). Accordingly, the four flow groove portions 13C disposed on the upper side of the three flow groove portions 13C constituting the flow groove portion group 134 are disposed adjacently on the upper side of the flow groove portion group 134, and constitute one group, that is, a flow groove portion group 135 in which the flow direction of the fuel is reversed.

Further, end portions on the other side-edge side (the left side in FIG. 3) of the four flow groove portions 13C constituting the flow groove portion group 135 are connected to an outflow groove portion 13G having a lower half shape of a semi-ellipse in a front view that extends downward from the fuel outflow port 17B formed in an upper end portion of the fuel electrode current collector 13 and that protrudes outward in the width direction. Accordingly, the fuel flowing into the outflow groove portion 13G from the four flow groove portions 13C constituting the flow groove portion group 135 flows from the fuel outflow port 17B to the fuel discharge pipe 61 (see FIG. 1).

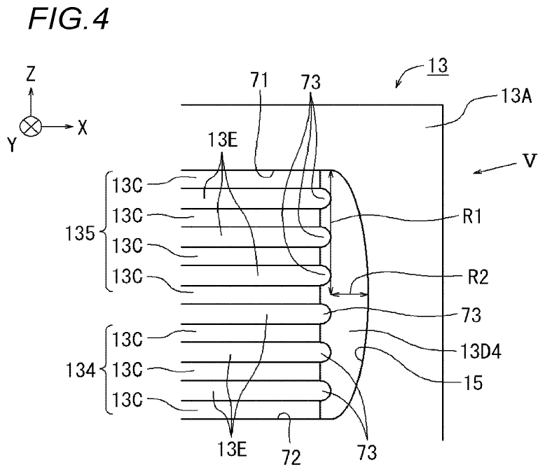

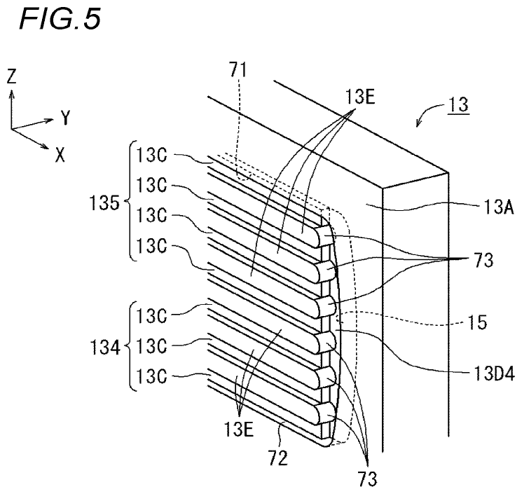

Here, a configuration of the return groove portion 13D4 will be described with reference to FIGS. 4 and 5. Note that the return groove portion 13D2 has substantially the same configuration as the return groove portion 13D4. The inflow groove portion 13F has substantially the same configuration as an upper half in the up-down direction of the return groove portion 13D4. In addition, each of the return groove portions 13D1 and 13D3 has a configuration substantially the same as the configuration of the return groove portion 13D4 that is linearly symmetrical with respect to a vertical line. The outflow groove portion 13G has substantially the same configuration as a lower half of the configuration of the return groove portion 13D4 that is linearly symmetrical with respect to a vertical line.

As illustrated in FIGS. 4 and 5, the return groove portion 131D4 is formed in a semi-elliptical shape in a front view extending in the up-down direction and protruding outward in the width direction, and is recessed in the thickness direction at a depth of about twice the depth of each of the flow groove portions 13C. Further, an inner wall surface portion 15, which faces the end portions on the one side-edge side (a right side in FIG. 4) of the flow groove portions 13C, is formed in a curved surface shape in which a distance from the inner wall surface portion 15 to the end portion of the flow groove portion 13C, which face each other, gradually decreases from a central portion in the up-down direction of the return groove portion 13D4 toward both end portions in the up-down direction of the return groove portion 13D4. Here, the inner wall surface portion 15 in the return groove portions 13D1 to 13D4 may be referred to as, for example, a first inner wall surface portion. The inner wall surface portion 15 in the inflow groove portion 13F may be referred to as, for example, a second inner wall surface portion. The inner wall surface portion 15 in the outflow groove portion 13G may be referred to as, for example, a third inner wall surface portion.

Specifically, for example, the inner wall surface portion 15 of the return groove portion 13D4 is formed in a semi-elliptical shape in a front view in which a length of about ½ of a distance from a side wall portion 71 on an upper side of the flow groove portion 13C located at an upper end to a side wall portion 72 on a lower side of the flow groove portion 13C located at a lower end is set as a long radius R1, and a length that is about twice the depth of the return groove portion 13D4, that is, about four times the depth of each flow groove portion 13C is set as a short radius R2.

In each end portion of each land portion (rib portion) 13E that faces the inner wall surface portion 15, a protruding portion 73 that protrudes in a circular arc shape in a plan view toward an outer side in the width direction with respect to the adjacent flow groove portions 13C is formed over an entire height of each land portion 13E from a bottom surface of the return groove portion 131D4. In addition, a major axis of the inner wall surface portion 15 having a semi-elliptical shape in a plan view is disposed, for example, so as to pass through a distal end portion of each of the protruding portions 73.

Accordingly, the fuel flowing through the flow groove portions 13C of the flow groove portion group 134 is guided by the respective protruding portions 73 and a lower portion of the inner wall surface portion 15, and smoothly flows to the lower side in the return groove portion 13D4. Then, the fuel flowing into the return groove portion 13D4 is guided upward in the return groove portion 13D4 by the respective protruding portions 73 and an upper portion of the inner wall surface portion 15, and flows into the flow groove portions 13C of the flow groove portion group 135.

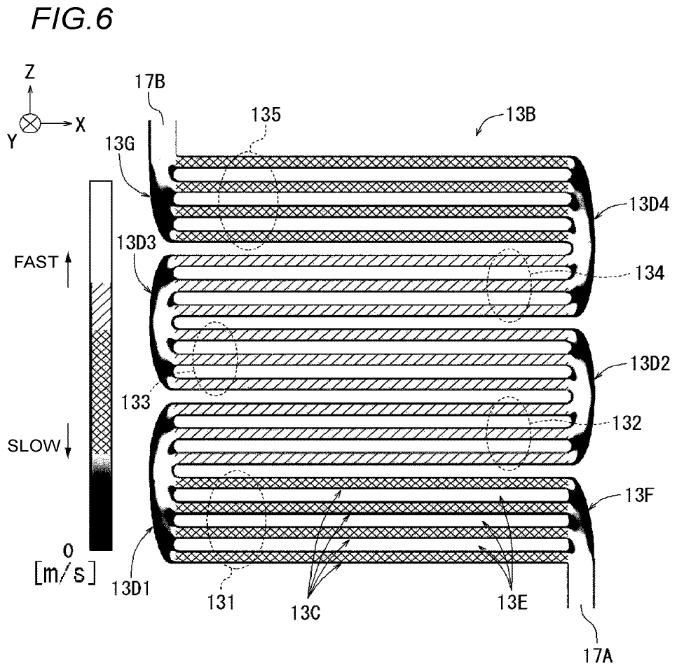

Next, an example of a result of flow speed distribution of the fuel, which is subjected to fluid analysis by computer-aided engineering (CAE) analysis at the time when the fuel of the aqueous solution of formic acid having a concentration of about 10% to 40% is supplied (pumped) to the fuel electrode current collector 13 of the fuel cell 7 configured as described above, will be described with reference to FIG. 6. As illustrated in FIG. 6, the fuel flowing into the inflow groove portion 13F from the fuel inflow port 17A formed in a lower end portion of the fuel electrode current collector 13 flows into the four flow groove portions 13C constituting the flow groove portion group 131 without a substantial stagnation.

Then, the fuel flowing into the return groove portion 13D1 from the four flow groove portions 13C constituting the flow groove portion group 131 flows into the three flow groove portions 13C constituting the flow groove portion group 132 without substantially stagnating in the return groove portion 13D1. Therefore, a flow speed of the fuel flowing through the three flow groove portions 13C constituting the flow groove portion group 132 is slightly higher than a flow speed of the fuel flowing through the four flow groove portions 13C constituting the flow groove portion group 131.

Subsequently, the fuel flowing into the return groove portion 13D2 from the three flow groove portions 13C constituting the flow groove portion group 132 flows into the three flow groove portions 13C constituting the flow groove portion group 133 without substantially stagnating in the return groove portion 13D2. Therefore, a flow speed of the fuel flowing through the three flow groove portions 13C constituting the flow groove portion group 133 is substantially the same as the flow speed of the fuel flowing through the three flow groove portions 13C constituting the flow groove portion group 132.

Then, the fuel flowing into the return groove portion 13D3 from the three flow groove portions 13C constituting the flow groove portion group 133 flows into the three flow groove portions 13C constituting the flow groove portion group 134 without substantially stagnating in the return groove portion 13D3. Therefore, a flow speed of the fuel flowing through the three flow groove portions 13C constituting the flow groove portion group 134 is substantially the same as the flow speed of the fuel flowing through the three flow groove portions 13C constituting the flow groove portion group 133.

Subsequently, the fuel flowing into the return groove portion 13D4 from the three flow groove portions 13C constituting the flow groove portion group 134 flows into the four flow groove portions 13C constituting the flow groove portion group 135 without substantially stagnating in the return groove portion 13D4. Therefore, a flow speed of the fuel flowing through the four flow groove portions 13C constituting the flow groove portion group 135 is slightly lower than the flow speed of the fuel flowing through the three flow groove portions 13C constituting the flow groove portion group 134.

Then, the fuel flowing into the outflow groove portion 13G from the four flow groove portions 13C constituting the flow groove portion group 135 flows into the fuel outflow port 17B without substantially stagnating in the outflow groove portion 13G and is discharged. Therefore, a flow speed of the fuel flowing through the fuel outflow port 17B is substantially the same as a flow speed of the fuel flowing through the fuel inflow port 17A.

As described above, in the inflow groove portion 13F, the return groove portions 13D1 to 13D4, and the outflow groove portion 13G, the distance from the inner wall surface portion 15 to the end portion of the flow groove portion 13C decreases toward the respective end portions in the up-down direction. Therefore, it is presumed that the inflow groove portion 13F, the return groove portions 13D1 to 131D4, and the outflow groove portion 130 have substantially no portions where the flow speed of the fuel at the respective end portions in the up-down direction is zero [m/sec] and the fuel stagnates.

As a result, carbon dioxide (CO₂) generated by the oxidation reaction of formic acid represented by the above formula (2) flows smoothly together with the fuel of the aqueous solution of formic acid through the flow groove portions 13C, and thus an occurrence that carbon dioxide accumulates to form bubbles in the inflow groove portion 13F, the return groove portions 13D1 to 13D4, and the outflow groove portion 13G, and the fuel (aqueous solution of formic acid) and carbon dioxide stagnate therein can be suppressed. That is, the oxidation reaction of the fuel (aqueous solution of formic acid) by the electrode catalyst particles of the fuel electrode catalyst layer 11 increases, and a decrease in a power generation amount of the fuel cell 7 can be suppressed.

### Comparative Example

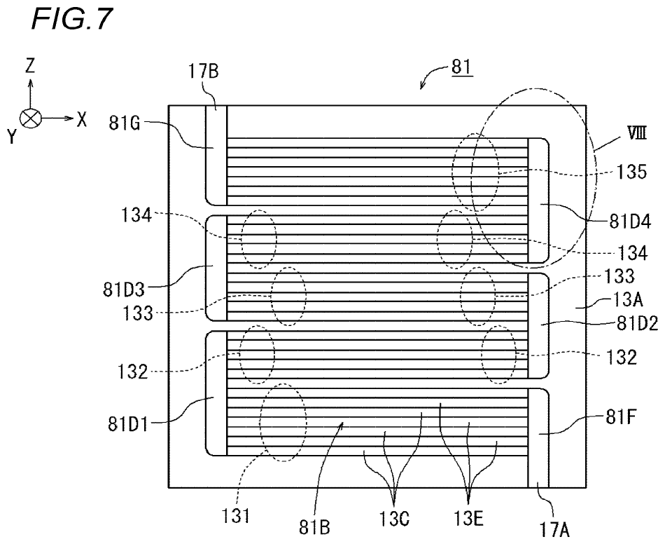

Here, a fuel electrode current collector 81 as a comparative example of the fuel electrode current collector 13 of the fuel cell 7 will be described with reference to FIGS. 7 to 9. Note that in the following description, the same reference signs as those of the configuration and the like of the fuel electrode current collector 13 according to the above-described embodiment denote portions same as or equivalent to those of the configuration and the like of the fuel electrode current collector 13 according to the above-described embodiment.

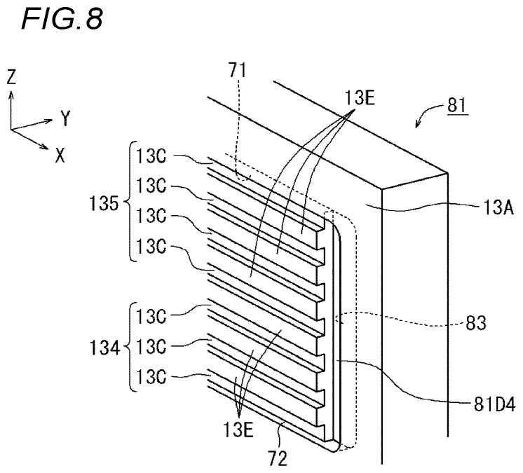

First, a configuration of the fuel electrode current collector 81 will be described with reference to FIGS. 7 and 8. As illustrated in FIGS. 7 and 8, the configuration of the fuel electrode current collector 81 is substantially the same as the configuration of the fuel electrode current collector 13. However, as illustrated in FIG. 7, the fuel electrode current collector 81 is different in that a fuel flow groove 81B is provided instead of the fuel flow groove 13B. In addition, the fuel electrode current collector 81 is different in that the protruding portions 73 are not formed in both end portions of each land portion (rib portion) 13E in the horizontal width direction.

Specifically, the fuel flow groove 81 is provided with a plurality of flow groove portions 13C that extend in the width direction from one side-edge side (for example, a right side-edge side in FIG. 7) of the fuel flow surface 13A to the other side-edge side (for example, a left side-edge side in FIG. 7), that are arranged in parallel at predetermined intervals, and in which the fuel flows. Further, end portions on the one side-edge side (the right side in FIG. 7) of four flow groove portions 13C on a lower end side is connected to an inflow groove portion 81F having a vertically long and substantially rectangular shape in a front view that extends upward from the fuel inflow port 17A formed in a lower end portion and that has a closed upper end portion. In addition, end portions on the other side-edge side (the left side in FIG. 7) of the four flow groove portions 13C on the lower end side, and end portions on the other side-edge side (the left side in FIG. 7) of three flow groove portions 13C on an upper side thereof, are connected to, for example, a return groove portion 81D1 having a vertically long and substantially rectangular shape in a front view that extends in the up-down direction and that protrudes outward in the width direction.

Accordingly, a fuel flowing into the inflow groove portion 81F from the fuel inflow port 17A flows into the four flow groove portions 13C on the lower end side, flows toward the other side-edge side (the left side in FIG. 7), and flows to a lower side of the return groove portion 81D1. Then, the fuel flowing into the return groove portion 81D1 flows into the three flow groove portions 13C disposed on an upper side of the return groove portion 81D1, and flows toward the one side-edge side (the right side in FIG. 7). Accordingly, the four flow groove portions 13C on the lower end side and the three flow groove portions 13C on the upper side thereof constitute two groups, that is, the flow groove portion groups 131 and 132 adjacent to each other in which flow directions of the fuel are opposite to each other.

In addition, end portions on the one side-edge side (the right side in FIG. 7) of the three flow groove portions 13C constituting the flow groove portion group 132, and end portions on the one side-edge portion (the right side in FIG. 7) of three flow groove portions 13C on an upper side thereof, are connected to, for example, a return groove portion 81D2 having a vertically long and substantially rectangular shape in a front view that extends in the up-down direction and that protrudes outward in the width direction.

Accordingly, the fuel flowing to a lower side of the return groove portion 81D2 from the three flow groove portions 13C constituting the flow groove portion group 132 flows into the three flow groove portions 13C disposed on an upper side of the return groove portion 81D2, and flows toward the other side-edge side (the left side in FIG. 7). Accordingly, the three flow groove portions 13C disposed on the upper side of the three flow groove portions 13C constituting the flow groove portion group 132 are disposed adjacently on the upper side of the flow groove portion group 132, and constitute one group, that is, the flow groove portion group 133 in which the flow direction of the fuel is reversed.

In addition, end portions on the other side-edge side (the left side in FIG. 7) of the three flow groove portions 13C constituting the flow groove portion group 133, and end portions on the other side-edge side (the left side in FIG. 7) of three flow groove portions 13C on an upper side thereof, are connected to, for example, a return groove portion 81D3 having a vertically long and substantially rectangular shape in a front view that extends in the up-down direction and that protrudes outward in the width direction.

Accordingly, the fuel flowing to a lower side of the return groove portion 81D3 from the three flow groove portions 13C constituting the flow groove portion group 133 flows into the three flow groove portions 13C disposed on an upper side of the return groove portion 13D3, and flows toward the one side-edge side (the right side in FIG. 3). Accordingly, the three flow groove portions 13C disposed on the upper side of the three flow groove portions 13C constituting the flow groove portion group 133 are disposed adjacently on the upper side of the flow groove portion group 133, and constitute one group, that is, the flow groove portion group 134 in which the flow direction of the fuel is reversed.

In addition, end portions on the one side-edge side (the right side in FIG. 7) of the three flow groove portions 13C constituting the flow groove portion group 134, and end portions on the one side-edge side (the right side in FIG. 7) of four flow groove portions 13C on an upper side thereof, are connected to, for example, a return groove portion 81D4 having a vertically long and substantially rectangular shape in a front view that extends in the up-down direction and that protrudes outward in the width direction.

Accordingly, the fuel flowing to a lower side of the return groove portion 81D4 from the three flow groove portions 13C constituting the flow groove portion group 134 flows into the four flow groove portions 13C disposed on an upper side of the return groove portion 81D4, and flows toward the other side-edge side (the left side in FIG. 7). Accordingly, the four flow groove portions 13C disposed on the upper side of the three flow groove portions 13C constituting the flow groove portion group 134 are disposed adjacently on the upper side of the flow groove portion group 134, and constitute one group, that is, the flow groove portion group 135 in which the flow direction of the fuel is reversed.

Further, end portions on the other side-edge side (left side in FIG. 7) of the four flow groove portions 13C constituting the flow groove portion group 135 are connected to an outflow groove portion 81G having a vertically long and substantially rectangular shape in a front view that extends downward from the fuel outflow port 17B formed in an upper end portion of the fuel electrode current collector 81 and that protrudes outward in the width direction. Accordingly, the fuel flowing into the outflow groove portion 81G from the four flow groove portions 13C constituting the flow groove portion group 135 flows from the fuel outflow port 17B to the fuel discharge pipe 61 (see FIG. 1).

Here, a configuration of the return groove portion 81D4 will be described with reference to FIGS. 7 and 8. Note that the return groove portion 81D2 has substantially the same configuration as the return groove portion 81D4. The inflow groove portion 81F has substantially the same configuration as an upper half of the return groove portion 81D4 in the up-down direction. In addition, each of the return groove portions 81D1 and 81D3 has substantially the same configuration as the return groove portion 81D4 that is linearly symmetrical with respect to a vertical line. The outflow groove portion 81G has substantially the same configuration as a lower half of the configuration of the return groove portion 81D4 that is linearly symmetrical with respect to a vertical line.

As illustrated in FIGS. 7 and 8, the return groove portion 81D4 is formed in a vertically long and substantially rectangular shape in a front view that extends in the up-down direction and that protrudes outward in the width direction, and is recessed in the thickness direction at a depth of about twice the depth of each of the flow groove portions 13C. In addition, an inner wall surface portion 83 facing the end portions on the one side-edge side (the right side in FIG. 8) of the flow groove portions 13C is formed so that a distance from the inner wall surface portion 83 to the end portion of the flow groove portion 13C, which face each other, is substantially constant over an entire length in the up-down direction.

Specifically, for example, the return groove portion 81D4 is formed in a vertically long and substantially rectangular shape in a front view in which a length of a distance from a side wall portion 71 on an upper side of the flow groove portion 13C located at an upper end to a side wall portion 72 on a lower side of the flow groove portion 13C located at a lower end is set as one side in the up-down direction, and a length of about twice the depth of the return groove portion 81D4, that is, about four times the depth of each flow groove portion 13C is set as one side in a left-right width direction.

Therefore, the end portions of the land portions (rib portions) 13E facing the inner wall surface portion 83 form a wall surface portion parallel to the inner wall surface portion 83 together with the end portions of the flow groove portions 13C facing the inner wall surface portion 83. That is, the fuel flow groove 81B is different from the fuel flow groove 13B in configuration in that each end portion of each land portion (rib portion) 13E facing the inner wall surface portion 83 is not provided with the protruding portion 73 having a circular arc shape in a plan view. Therefore, the fuel flowing through the flow groove portions 13C of the flow groove portion group 134 flows to the lower side in the return groove portion 81D4. Then, the fuel flowing into the return groove portion 81D4 is guided upward in the return groove portion 81D4 by an upper side portion of the inner wall surface portion 83, and flows into the flow groove portions 13C of the flow groove portion group 135.

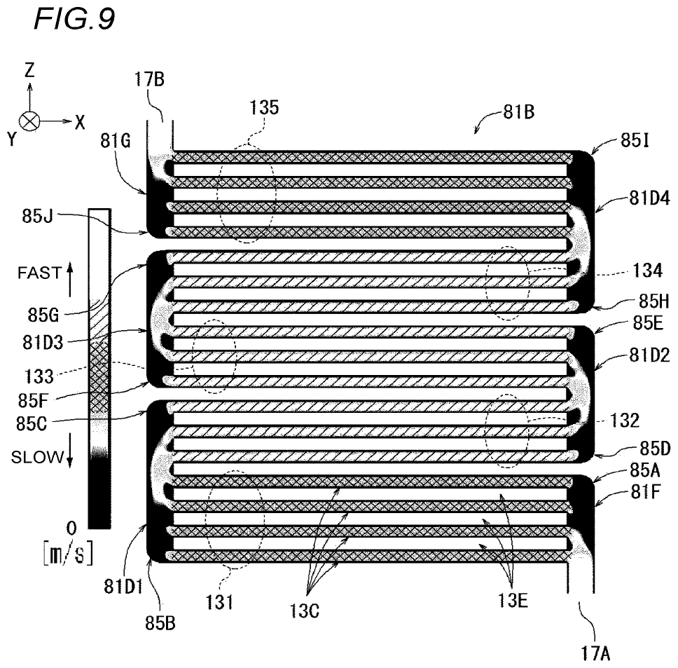

Next, an example of a result of flow speed distribution of the fuel, which is subjected to fluid analysis by computer-aided engineering (CAE) analysis at the time when the fuel of the aqueous solution of formic acid having a concentration of about 10% to 40% is supplied (pumped) to the fuel electrode current collector 81 of the fuel cell 7 configured as described above, will be described with reference to FIG. 9. As illustrated in FIG. 9, the fuel flowing into the inflow groove portion 81F from the fuel inflow port 17A formed in a lower end portion of the fuel electrode current collector 81 flows into the four flow groove portions 13C constituting the flow groove portion group 131, and a stagnation region 85A where the flow speed is substantially zero [m/sec] is formed at an upper end corner portion on an outer side in the width direction (a right side in FIG. 9) of the inflow groove portion 81F.

Then, the fuel flowing into the return groove portion 81D1 from the four flow groove portions 13C constituting the flow groove portion group 131 flows into the three flow groove portions 13C constituting the flow groove portion group 132, and stagnation regions 85B and 85C where the flow speed is substantially zero [m/sec] are formed respectively at a lower end corner portion and an upper end corner portion on the outer side in the width direction (a left side in FIG. 9) of the return groove portion 81D1. A flow speed of the fuel flowing through the three flow groove portions 13C constituting the flow groove portion group 132 is slightly higher than a flow speed of the fuel flowing through the four flow groove portions 13C constituting the flow groove portion group 131.

Subsequently, the fuel flowing into the return groove portion 81D2 from the three flow groove portions 13C constituting the flow groove portion group 132 flows into the three flow groove portions 13C constituting the flow groove portion group 133, and stagnation regions 85D and 85E where the flow speed is substantially zero [m/sec] are formed respectively at a lower end corner portion and an upper end corner portion on the outer side in the width direction (the right side in FIG. 9) of the return groove portion 81D2. In addition, a flow speed of the fuel flowing through the three flow groove portions 13C constituting the flow groove portion group 133 is substantially the same as the flow speed of the fuel flowing through the three flow groove portions 13C constituting the flow groove portion group 132.

Then, the fuel flowing into the return groove portion 81D3 from the three flow groove portions 13C constituting the flow groove portion group 133 flows into the three flow groove portions 13C constituting the flow groove portion group 134, and stagnation regions 85F and 85G where the flow speed is substantially zero [m/sec] are formed respectively at a lower end corner portion and an upper end corner portion on the outer side in the width direction (the left side in FIG. 9) of the return groove portion 81D3. In addition, a flow speed of the fuel flowing through the three flow groove portions 13C constituting the flow groove portion group 134 is substantially the same as the flow speed of the fuel flowing through the three flow groove portions 13C constituting the flow groove portion group 133.

Subsequently, the fuel flowing into the return groove portion 81D4 from the three flow groove portions 13C constituting the flow groove portion group 134 flows into the four flow groove portions 13C constituting the flow groove portion group 135, and stagnation regions 85H and 85I where the flow speed is substantially zero [m/sec] are formed respectively at a lower end corner portion and an upper end corner portion on the outer side in the width direction (the right side in FIG. 9) of the return groove portion 81D4. In addition, a flow speed of the fuel flowing through the four flow groove portions 13C constituting the flow groove portion group 135 is slightly lower than the flow speed of the fuel flowing through the three flow groove portions 13C constituting the flow groove portion group 134.

Then the fuel flowing into the outflow groove portion 81G from the four flow groove portions 13C constituting the flow groove portion group 135 flows into the fuel outflow port 17B and is discharged, and a stagnation region 853 where the flow speed is substantially zero [m/sec] is formed at a lower end corner portion on the outer side in the width direction (the left side in FIG. 9) of the outflow groove portion 81G. Therefore, a flow speed of the fuel flowing through the fuel outflow port 17B is substantially the same as a flow speed of the fuel flowing through the fuel inflow port 17A.

As described above, the inflow groove portion 81F, the return groove portions 81D 1 to 81D4, and the outflow groove portion 81G are formed in a vertically long and substantially rectangular shape in a front view that extends in the up-down direction and that protrudes outward in the width direction. Therefore, it is presumed that the inflow groove portion 81F, the return groove portions 81D1 to 81D4, and the outflow groove portion 81G are formed with the stagnation regions 85A to 85J, in which the flow speed of the fuel is substantially zero [m/sec], at the upper end corner portions and the lower end corner portions on the outer sides in the width direction.

Therefore, carbon dioxide (CO₂) generated by the oxidation reaction of formic acid represented by the above formula (2) stagnates together with the fuel of the aqueous solution of formic acid in the stagnation regions 85A to 85J and becomes bubbles, and there is a possibility that carbon dioxide remains on surfaces of the electrode catalyst particles (for example, Pd) of the fuel electrode catalyst layer 11. As a result, since formic acid is less likely to be adsorbed on the surfaces of the electrode catalyst particles when carbon dioxide remains on the surfaces of the electrode catalyst particles (for example, Pd) of the fuel electrode catalyst layer 11, there is a possibility that procession of the oxidation reaction of formic acid represented by the above formula (2) is hindered and the power generation amount of the fuel cell 7 is reduced.

As described above in detail, in the fuel cell 7 according to the present embodiment, the distance from the inner wall surface portion 15 to the end portion of the flow groove portion 13C decreases toward the respective end portions in the up-down direction in the inflow groove portion 13F, the return groove portions 13D1 to 13D4, and the outflow groove portion 13G, which constitute the fuel flow groove 13B of the fuel electrode current collector 13. That is, the inner wall surface portion 15 of the inflow groove portion 13F, the return groove portions 13D1 to 13D4, and the outflow groove portion 13G is formed in a curved surface shape in which the distance from the inner wall surface portion 15 to the end portion of the flow groove portion 13C, which face each other, gradually decreases toward both end portions in the up-down direction.

Accordingly, the inflow groove portion 13F, the return groove portions 13D1 to 13D4, and the outflow groove portion 13G have substantially no portions where the flow speed of the fuel at the respective end portions in the up-down direction is zero [m/sec] and the fuel stagnates. As a result, carbon dioxide (CO₂) generated by the oxidation reaction of formic acid represented by the above formula (2) flows smoothly together with the fuel of the aqueous solution of formic acid through the flow groove portions 13C, and thus an occurrence that carbon dioxide accumulates to form bubbles in the inflow groove portion 13F, the return groove portions 13D1 to 13D4, and the outflow groove portion 13G, and the fuel (aqueous solution of formic acid) and carbon dioxide stagnate therein can be suppressed. That is, the oxidation reaction of the fuel (aqueous solution of formic acid) by the electrode catalyst particles of the fuel electrode catalyst layer 11 increases, and a decrease in the power generation amount of the fuel cell 7 can be suppressed.

In addition, the plurality of land portions 13E disposed between the flow groove portions 13C have, at the end portions thereof facing the inner wall surface portion 15, the protruding portions 73 that protrude in a circular arc shape in a plan view toward the outer side with respect to the adjacent flow groove portions 13C. Accordingly, the fuel flowing out of the flow groove portion 13C can be smoothly guided along an outer peripheral surface of the protruding portion 73 to the upper side, and then smoothly guided again into the flow groove portion 13C disposed on the upper side, and the fuel and carbon dioxide stagnating at the end portions in the up-down direction of the return groove portions 13D1 to 13D4, the inflow groove portion 13F, or the outflow groove portion 13G can be further reduced.

It goes without saying that the present disclosure is not limited to the above-described embodiment, and various improvements, modifications, additions, and deletions can be made without departing from the gist of the present disclosure. Note that in the following description, the same reference signs as those of the configuration and the like of the fuel cell system 1 according to the above-described embodiment illustrated in FIGS. 1 to 6 denote portions same as or equivalent to those of the configuration and the like of the fuel cell system 1 according to the above-described embodiment.

### Other First Embodiment

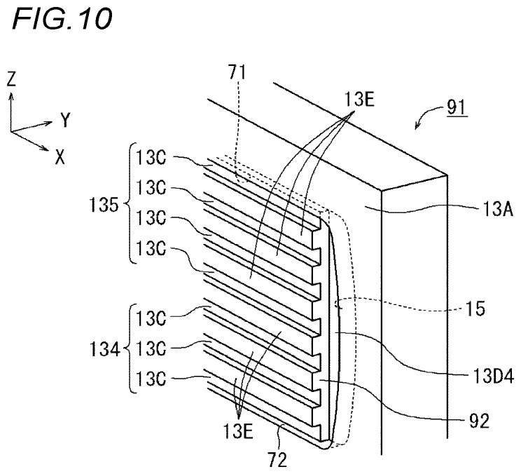

(A) For example, a fuel electrode current collector 91 illustrated in FIG. 10 may be used instead of the fuel electrode current collector 13. A configuration of the fuel electrode current collector 91 will be described with reference to FIG. 10. As illustrated in FIG. 10, the fuel electrode current collector 91 has substantially the same configuration as the fuel electrode current collector 13, but is different in that both end portions in the horizontal width direction of each land portion 13E is not formed with the protruding portion 73. Therefore, the end portions of the land portions (rib portions) 13E facing the inner wall surface portion 15 form a flat portion 92 along the vertical direction together with the end portions of the flow groove portions 13C facing the inner wall surface portion 15.

Further, as illustrated in FIG. 10, the inner wall surface portion 15 facing the flat portion 92 is formed in a curved surface shape in which a distance from the inner wall surface portion 15 to the end portion of the flow groove portion 13C, which face each other, gradually decreases from a central portion in the up-down direction of the return groove portion 13D4 toward both end portions in the up-down direction of the return groove portion 13D4. Accordingly, the fuel flowing into the return groove portion 13D4 from the flow groove portions 13C of the flow groove portion group 134 is guided upward by the flat portion 92 and the inner wall surface portion 15, and flows into the flow groove portions 13C of the flow groove portion group 135.

Therefore, the fuel flowing into the return groove portion 13D4 from the three flow groove portions 13C constituting the flow groove portion group 134 flows into the four flow groove portions 13C constituting the flow groove portion group 135 without substantially stagnating in the return groove portion 13D4. Similarly, in the inflow groove portion 13F, the return groove portions 13D1 to 13D4, and the outflow groove portion 13G, the distance from the inner wall surface portion 15 to the end portion of the flow groove portion 13C decreases toward the respective end portions in the up-down direction. Therefore, it is presumed that the inflow groove portion 13F, the return groove portions 13D1 to 13D4, and the outflow groove portion 13G have substantially no portions where the flow speed of the fuel at the respective end portions in the up-down direction is zero [m/sec] and the fuel stagnates.

As a result, carbon dioxide (CO₂) generated by the oxidation reaction of formic acid represented by the above formula (2) flows smoothly together with the fuel of the aqueous solution of formic acid through the flow groove portions 13C, and thus an occurrence that carbon dioxide accumulates to form bubbles in the inflow groove portion 13F, the return groove portions 13D1 to 13D4, and the outflow groove portion 13G, and the fuel (aqueous solution of formic acid) and carbon dioxide stagnate therein can be suppressed. That is, the oxidation reaction of the fuel (aqueous solution of formic acid) by the electrode catalyst particles of the fuel electrode catalyst layer 11 increases, and a decrease in the power generation amount of the fuel cell 7 can be suppressed.

### Other Second Embodiment

(B) For example, a protruding height of the protruding portion 73 protruding from both end portions of each land portion 13E in the horizontal width direction to the inside of each of the return groove portions 13D1 to 13D4 may be gradually decreased from both end portions in the up-down direction of each of the return groove portions 13D1 to 13D4 toward a portion between adjacent flow groove portion groups 131 to 135 in which the flow directions of the fuel are reversed. Accordingly, the fuel flowing into the return groove portions 13D1 to 13D4 from the flow groove portions 13C can be guided so as to smoothly flow to a substantially central portion in the up-down direction, and the fuel and carbon dioxide stagnating at both end portions in the up-down direction of the return groove portions 13D1 to 13D4 can be further reduced.

The present application is based on Japanese Patent Application No. 2019-189185 filed on Oct. 16, 2019, the contents of which are incorporated herein as reference.

1. A fuel cell being a direct liquid fuel cell in which a liquid containing a formic acid or an alcohol is used as a fuel, the fuel cell comprising:
a fuel electrode that includes a fuel electrode catalyst layer, a fuel electrode diffusion layer, and a fuel electrode current collector;
an air electrode that includes an air electrode catalyst layer, an air electrode diffusion layer, and an air electrode current collector; and
an electrolyte membrane that is disposed between the fuel electrode catalyst layer and the air electrode catalyst layer,
wherein the fuel electrode current collector has:
a fuel inflow port to which the fuel is supplied;
a fuel outflow port from which the fuel is discharged; and
a fuel flow groove that is formed on a fuel flow surface on a side abutting the fuel electrode diffusion layer and guides the fuel from the fuel inflow port to the fuel outflow port,
wherein the fuel flow groove has:
a plurality of flow groove portions that extend from one side edge portion of the fuel flow surface to the other side edge portion opposite to the one side edge portion and that are disposed in parallel at predetermined intervals; and
a plurality of return groove portions that, in a manner of containing a plurality of groups adjacent to each other with directions of the fuel flowing in the plurality of flow groove portions being opposite, connect an end portion of the one side edge portion or an end portion of the other side edge portion of two adjacent groups among the plurality of groups in the plurality of flow groove portions,
wherein each of the plurality of return groove portions has a first inner wall surface portion facing the end portion of the flow groove portions in the plurality of return groove portions, and
wherein the first inner wall surface portion has a curved surface shape in which a distance facing with each other from the first inner wall surface portion to the end portion of the flow groove portions, gradually decreases toward both end portions of the first inner wall surface portion in a direction orthogonal to an extending direction of the flow groove portions.

2. The fuel cell according to claim 1,
wherein the fuel flow groove has an inflow groove portion that is connected to the fuel inflow port and to which an end portion on a side opposite to the return groove portion of one group among the plurality of groups in the plurality of flow groove portions is connected, the one group of the plurality of flow groove portions being configured such that the fuel first flows therein,
wherein the inflow groove portion has a second inner wall surface portion facing the end portion of the flow groove portions in the inflow groove portion, and
wherein the second inner wall surface portion has a curved surface shape in which a distance facing with each other from the second inner wall surface portion to the end portion of the flow groove portions, gradually decreases toward an outflow side end portion of the second inner wall surface portion in a direction orthogonal to an extending direction of the flow groove portions.

3. The fuel cell according to claim 1 or 2,
wherein the fuel flow groove has an outflow groove portion that is connected to the fuel outflow port and to which an end portion on a side opposite to the return groove portion of one group among the plurality of groups in the plurality of flow groove portions is connected, the one group of the plurality of flow groove portions being configured such that the fuel lastly flows therein,
wherein the outflow groove portion has a third inner wall surface portion facing the end portion of the flow groove portions in the outflow groove portion, and
wherein the third inner wall surface portion has a curved surface shape in which a distance facing with each other from the third inner wall surface portion to the end portion of the flow groove portions, gradually decreases toward an inflow side end portion of the third inner wall surface portion in a direction orthogonal to an extending direction of the flow groove portions.

4. The fuel cell according to any one of claims 1 to 3,
wherein the fuel flow groove has a plurality of rib portions that are disposed between the plurality of flow groove portions, and
wherein the plurality of rib portions have a plurality of protruding portions protruding in a circular arc shape in a plan view outward from the flow groove portions, at the end portion of the flow groove portions facing each of the first inner wall surface portion, the second inner wall surface portion, and the third inner wall surface portion.

5. The fuel cell according to claim 4,
wherein the plurality of protruding portions protruding into the return groove portion are formed such that a protruding height of the protruding portion gradually decreases from both end portions of the return groove portion in a direction orthogonal to the extending direction of the flow groove portions toward a boundary, at which a direction of the fuel flowing in the two groups is reversed, between two groups of the flow groove portions among the plurality of groups.
